(19) United States
(12) Patent Application Publication
(10) Pub. No.: US 2009/0083053 A1
(43) Pub. Date: Mar. 26, 2009

(54) Method for Linking Intellectual Property System to Other System and the System

(75) Inventor: Ul-Ho Lee, Gyeonggi-do (KR)

Correspondence Address: HARNESS, DICKEY & PIERCE, P.L.C., P.O. BOX 8910, RESTON, VA, 20195, US

(73) Assignee: FOSPAT INCORPORATED, Seoul (KR)

(21) Appl. No.: 11/887,413

(22) PCT Filed: Mar. 30, 2006
(86) PCT No.: PCT/KR2006/001159

§ 371 Date: Nov. 26, 2008

(30) Foreign Application Priority Data
Apr. 4, 2005 (KR) 10-2005-0027867

(51) Int. Cl. G06Q 99/00

(52) U.S. Cl. 705/1

(57) ABSTRACT

Provided are a method and system capable of reducing unnecessary developing and operating costs by implementing data exchange or screen association in different intellectual property information systems having different server from each other. The method associates at least first and second different intellectual property related systems operated by different servers from each other. The method includes the steps of: providing, by the first intellectual property information system, identification of requested information to the second intellectual property information system; and providing, by the second intellectual property information system, a link to information corresponding to the identification, or opening a page corresponding to the identification.

### TECHNICAL FIELD

The present invention relates to a method and system capable of reducing unnecessary developing and operating costs by implementing data exchange or screen association between different intellectual property information systems having different servers from each other.

### BACKGROUND ART

Korean Patent Laid-open Publication No. 2002-0094541 discloses a system which manages researchers suggestions of inventions for patent application, appointment of patent attorneys, receipt and review of draft applications, and the like, in a company.

An applicant—or patent attorney—developed and operated intellectual property information system and a patent office or commercial patent search database exist as separate entities.

They manage different information and are operated separately to maximize their functions.

The applicant—or patent attorney—operated intellectual property information system provides detailed information including invention summaries and applications drafted by applicants or patent attorneys. However, such a system provides little or no information on published applications, prior art references cited in examination, and intellectual property rights including others patent applications and patents. Thus, it is necessary to separately access other intellectual property information systems, e.g., the patent office's intellectual property information system, to obtain the information, and this is inconvenient.

### DISCLOSURE OF INVENTION

### Technical Problem

It is an object of the present invention to provide a method and system capable of reducing unnecessary developing and operating costs by implementing data exchange or screen association between different intellectual property information systems having different servers from each other.

### Technical Solution

A first aspect of the present invention provides a method of associating at least first and second different intellectual property related systems operated by different servers from each other, the method comprising the steps of: providing, by the first intellectual property information system, identification of requested information to the second intellectual property information system; and providing, by the second intellectual property information system, a link to information corresponding to the identification, or opening a page corresponding to the identification.

A second aspect of the present invention provides a method of associating at least first and second different intellectual property related systems operated by different servers from each other, the method comprising the steps of: providing, by the first intellectual property information system, identification of requested information to the second intellectual property information system; providing, by the second intellectual property information system, location information of information or a page corresponding to the identification to the first intellectual property information system; storing the location information of the information or page provided by the second intellectual property information system in a storage unit of a server of the first intellectual property information system; requesting the second intellectual property information system to provide the location information of the information or page stored in the storage unit of the server of the first intellectual property information system; and providing, by the second intellectual property information system, a link to information corresponding to the location information of the information or page, or opening a page corresponding to the location information.

Thus, a user of one intellectual property information system can conveniently use intellectual property information and related screen information provided by other systems without performing a separate access procedure.

Intellectual property information systems A 101, 201, 301, and 401 and intellectual property information systems B 102, 202, 302, and 402 of the present invention shown in FIGS. 1 to 4 are operated by different servers (i.e., server A and server B), manage different information, and have different screen structures. Preferably, the intellectual property information system A is a system operated by applicants or patent attorneys in a company or institution, and manages invention suggestion, draft patent applications, and data and files for patent applications. The intellectual property information system B is a system operated by a patent office of a country or a published intellectual property right search system. When the intellectual property information system B is a post-publication information search system, a user can conveniently inquire, via the intellectual property information system A, information provided by the intellectual property information system B by utilizing location information of a page or original text of the intellectual property information system B without separately storing post-publication information in a server or separately building a page or original text for inquiring about the information.

### BRIEF DESCRIPTION OF THE DRAWINGS

FIG. 1 illustrates different intellectual property information systems associated with each other according to a first embodiment of the present invention;

FIG. 2 illustrates different intellectual property information systems associated with each other according to a second embodiment of the present invention;

FIG. 3 illustrates different intellectual property information systems associated with each other according to a third embodiment of the present invention; and

FIG. 4 illustrates different intellectual property information systems associated with each other according to a fourth embodiment of the present invention.

### MODE FOR THE INVENTION

Hereinafter, exemplary embodiments of the present invention will be described in detail with reference to the accompanying drawings. For the sake of clarity and conciseness, matters related to the invention that are well known in the art will not be described.

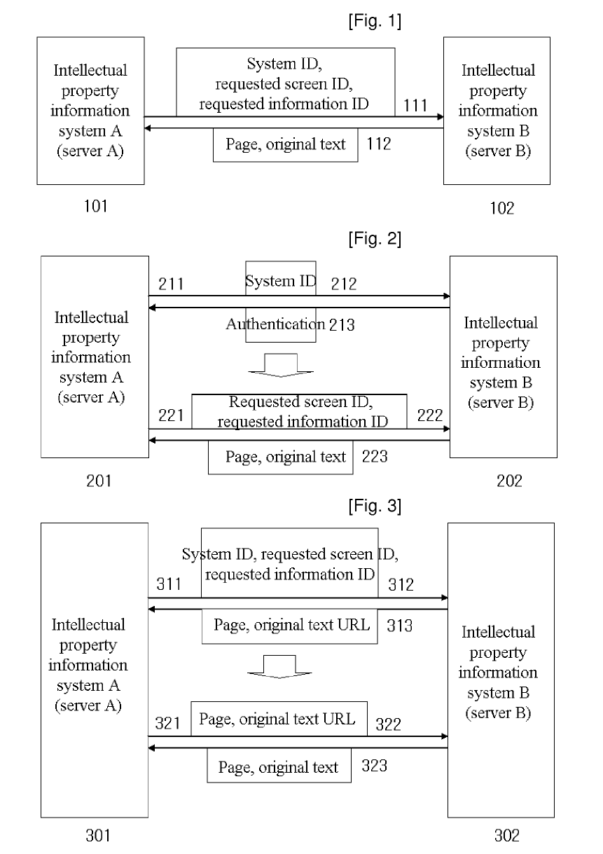

FIG. 1 illustrates different intellectual property information systems associated with each other according to a first embodiment of the present invention.

Intellectual property information system A 101 and intellectual property information system B 102 are operated by different servers (i.e., server A and server B). The intellectual property information system A 101 provides system identification (ID) for identifying itself, identification (ID) of requested information, and identification (ID) of a requested screen, to the intellectual property information system B 102 (111). The intellectual property information system B 102 authenticates the intellectual property information system A 101 based on the system identification (ID) and provides a page or original text having the requested information (112).

Preferably, the identification (ID) of the requested information is composed of a country code, a right classification, a serial number classification, a serial number, or a combination thereof.

Preferably, the requested screen is a screen including an original text or bibliographic information. When a plurality of cases are selected, the requested screen is a screen displaying all the selected patents, including basic bibliographic information and a representative figure of each case.

FIG. 2 illustrates different intellectual property information systems associated with each other according to a second embodiment of the present invention.

Intellectual property information system A 201 and intellectual property information system B 202 are operated by different servers. The intellectual property information system A 201 provides system identification (ID) for identifying itself to the intellectual property information system B 202 (212). The intellectual property information system B 202 authenticates the intellectual property information system A 201 based on the system identification (ID) so that the intellectual property information system A 201 stays authenticated until it is disconnected from intellectual property information system B 202 (211). The intellectual property information system A 201 then provides identification (ID) of requested information and identification (ID) of a requested screen to the intellectual property information system B 202 (222). The intellectual property information system B 202 provides the requested screen corresponding to the identification (ID) of the requested information to the intellectual property information system A 201 (223).

Preferably, the identification (ID) of the requested information is composed of a country code, a right classification, a serial number classification, a serial number, or a combination thereof.

Preferably, the requested screen is a screen including an original text or bibliographic information. When a plurality of patent cases are selected, the requested screen is a screen displaying all the selected patents, including basic bibliographic information and a representative figure of each case.

FIG. 3 illustrates different intellectual property information systems associated with each other according to a third embodiment of the present invention.

Intellectual property information system A 301 and intellectual property information system B 302 are operated by different servers. The intellectual property information system A 301 provides system identification (ID) for identifying itself, identification (ID) of requested information, and identification (ID) of a requested screen to the intellectual property information system B 302 (311). The intellectual property information system B 302 authenticates the intellectual property information system A 301 based on the system identification (ID), and then provides location information of a page or original text corresponding to the identification (ID) of the requested information to the intellectual property information system A 301 (313). The intellectual property information system A 301 stores the location information in a storage unit of a server, and requests the intellectual property information system B 302 to provide the stored location information (322). The intellectual property information system B 302 provides the page or original text to the intellectual property information system A 301 (323).

Thus, it is possible to reduce a frequency with which the intellectual property management system B 302 searches for the page or original text information corresponding to the identification (ID) of the requested information each time it is requested, thus reducing a load on a server.

Preferably, the identification (ID) of the requested information is composed of a country code, a right classification, a serial number classification, a serial number, or a combination thereof.

Preferably, the requested screen is a screen including an original text or bibliographic information. When a plurality of cases are selected, the requested screen is a screen displaying all the selected patents, including basic bibliographic information and a representative figure of each case.

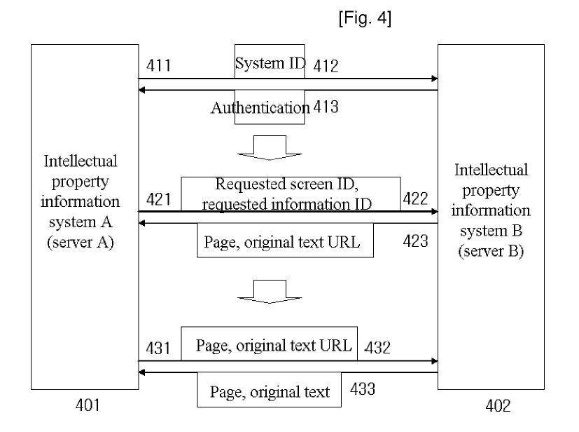

FIG. 4 illustrates different intellectual property information systems associated with each other according to a fourth embodiment of the present invention.

Intellectual property information system A 401 and intellectual property information system B 402 are operated by different servers. The intellectual property information system A 401 provides system identification (ID) for identifying itself to the intellectual property information system B 402 (412). The intellectual property information system B 402 authenticates the intellectual property information system A 401 based on the system identification (ID) (413), in which the intellectual property information system A 401 stays authenticated until it is disconnected from the intellectual property information system B 402 (411). The intellectual property information system A 401 provides the identification (ID) of requested information and identification (ID) of a requested screen to the intellectual property information system B 402 (421). The intellectual property information system B 402 provides location information of a page or original text corresponding to the identification (ID) of the requested information to the intellectual property information system A 401 (423). The intellectual property information system A 401 stores the location information in a storage unit of a server, and requests the intellectual property information system B 402 to provide the stored location information (432). The intellectual property information system B 402 provides the page or original text to the intellectual property information system A 401 (433).

Thus, it is possible to reduce a frequency with which the intellectual property management system B 402 searches for the page or original text information corresponding to the identification (ID) of the requested information each time it's requested, thus reducing a load on a server.

Preferably, the identification (ID) of the requested information is composed of a country code, a right classification, a serial number classification, a serial number, or a combination thereof.

Preferably, the requested screen is a screen including an original text or bibliographic information. When a plurality of cases are selected, the requested screen is a screen displaying all the selected patents, including basic bibliographic information and a representative figure of each case.

### INDUSTRIAL APPLICABILITY

With the above system, the original text information and examination information of intellectual property published or registered after application can be inquired about. In addition, prior patent applications and patents related to the applicant's intellectual property rights can be searched for on an applicant's system without having to access another system, i.e., a patent office system, and perform a search by a serial number, thus enhancing user convenience and reducing developing cost and server operating cost.

Particularly, published intellectual property information can be searched for on the applicant or patent attorney's intellectual property information system in a company and an institution through association between the applicant or patent attorney's intellectual property information system and a patent office or an intellectual property search system for providing published intellectual property rights without separately storing the published intellectual property information or separately implementing a screen for searching for an original text.

While the present invention has been described with reference to exemplary embodiments thereof, it will be understood by those skilled in the art that various changes in from and detail may be made therein without departing from the scope of the present invention as defined by the following claims.

1. A method of associating at least first and second different intellectual property related systems operated by different servers from each other, the method comprising the steps of: providing, by the first intellectual property information system, identification of requested information to the second intellectual property information system; and providing, by the second intellectual property information system, a link to information corresponding to the identification, or opening a page corresponding to the identification.

2. A method of associating at least first and second different intellectual property related systems operated by different servers from each other, the method comprising the steps of: providing, by the first intellectual property information system, identification of requested information to the second intellectual property information system; providing, by the second intellectual property information system, location information of a page or information corresponding to the identification to the first intellectual property information system; storing the location information of the page or information provided by the second intellectual property information system in a storage unit of a server of the first intellectual property information system; requesting the second intellectual property information system to provide the location information of the page or information stored in the storage unit of the server of the first intellectual property information system; and providing, by the second intellectual property information system, a link to information corresponding to the location information of the page or information, or opening a page corresponding to the location information.

3. The method of claim 2, further comprising the steps of: providing, by the first intellectual property information system, identification of the first intellectual property information system or a server of the first intellectual property information system, to the second intellectual property information system or a server of the second intellectual property information system; and authenticating, by the second intellectual property information system, the first intellectual property information system or the server of the first intellectual property information system based on the identification.

4. The method of claim 2, wherein the first intellectual property information system is an intellectual property information system operated by an applicant or patent attorney.

5. The method of claim 2, wherein the second intellectual property information system is an intellectual property information system of a patent office or an intellectual property search system for providing published intellectual property information.

6. The method of claim 2, wherein the identification of the requested information comprises a country code, a right classification, a serial number classification, a serial number, or a combination thereof.

7. The method of claim 2, wherein the requested information is an original text of a laid-open publication or registered intellectual property publication.

8. The method of claim 2, wherein the requested information is a screen providing an application serial number, an application date, and a title of intellectual property corresponding to the identification of the requested information provided by the second intellectual property information system.

9. The method of claim 1, further comprising the steps of: providing, by the first intellectual property information system, identification of the first intellectual property information system or a server of the first intellectual property information system, to the second intellectual property information system or a server of the second intellectual property information system: and authenticating, by the second intellectual property information system, the first intellectual property information system or the server of the first intellectual property information system based on the identification.

10. The method of claim 1, wherein the first intellectual property information system is an intellectual property information system operated by an applicant or patent attorney.

11. The method of claim 1, wherein the second intellectual property information system is an intellectual property information system of a patent office or an intellectual property search system for providing published intellectual property information.

12. The method of claim 1, wherein the identification of the requested information comprises a country code, a right classification, a serial number classification, a serial number, or a combination thereof.

13. The method of claim 1, wherein the requested information is an original text of a laid-open publication or registered intellectual property publication.

14. The method of claim 1, wherein the requested information is a screen providing an application serial number, an application date, and a title of intellectual property corresponding to the identification of the requested information provided by the second intellectual property information system.
